(19) United States
(12) Patent Application Publication
(10) Pub. No.: US 2022/0151227 A1
(43) Pub. Date: May 19, 2022

(54) CARNIVOROUS WASP CONTROL AGENT

(71) Applicant: EARTH CORPORATION, Chiyoda-ku, Tokyo (JP)

(72) Inventors: Ren ABE, Ako City, Hyogo (JP); Kazuki MAEDA, Ako City, Hyogo (JP)

(21) Appl. No.: 17/432,877

(22) PCT Filed: Feb. 6, 2020
(86) PCT No.: PCT/JP2020/004612

§ 371 Date: Aug. 20, 2021

(30) Foreign Application Priority Data
Feb. 21, 2019 (JP) 2019-029652

(51) Int. Cl. A01N 31/02; A01N 31/06; A01N 37/02; A01N 37/06; A01N 37/10; A01N 43/16; A01N 25/06

(52) U.S. Cl. CPC A01N 31/02; A01N 31/06; A01N 37/02; A01P 7/04; A01N 37/10; A01N 43/16; A01N 25/06; A01N 37/06

(57) ABSTRACT

An object is to provide a chemical agent that, when used on carnivorous wasps such as those belonging to the Vespidae family, instantly stops them from behaving normally, to prevent injuries caused by stings and bites. As a solution, a carnivorous wasp control agent is provided, which is characterized in that it contains, as an active ingredient, at least one type of compound selected from the group that consists of (a) cyclic monoterpene-based compounds, (b) chain monoterpene-based aldehyde compounds, (c) chain sesquiterpene-based compounds, (d) benzoic acid alkyl esters, (e) lactic acid alkyl esters, (f) octanols, and (g) phenylacetic acid esters.

### TECHNICAL FIELD

The present invention relates to a control agent for carnivorous wasps. More specifically, the present invention relates to a carnivorous wasp control agent containing a cyclic monoterpene-based compound, etc., as an active ingredient.

### BACKGROUND ART

Injuries caused by bees and wasps are increasing in number and creating problems in recent years. There are approx. 3,000 known species of wasps in Japan, including approx. 20 species of carnivorous wasps with strong stings and bites. Among the carnivorous wasps, those belonging to the Vespidae family such as hornets and paper wasps are very aggressive, and because their stings and bites can cause anaphylactic shock, and also because their stingers are structured to permit multiple attacks, they are among injurious insect pests against which there is a high demand for control where the wasps must be killed quickly.

Carnivorous wasps may build nests under the eaves or above the ceilings of residential houses, and in cities where the areas inhabited by humans overlap the range of activity of carnivorous wasps, injuries caused by their stings and bites tend to occur frequently. Since carnivorous wasps are belligerent, people who unknowingly approach their nests can be attacked and injured. For example, around 10 to 20 deaths from stings and bites of carnivorous wasps are reported every year.

Methods for preventing and removing bees and wasps generally use liquids or aerosols containing active insecticidal ingredients which are directly sprayed on the bees and wasps to be controlled, and many aerosols have been proposed that contain fast-acting pyrethroid insecticides, etc., as active ingredients (refer to Patent Literatures 1 to 3, etc., for example). Even when these aerosols are used, however, if a sufficient quantity is not sprayed on each wasp, or if the agitated wasps release an alarm pheromone before the insecticidal effect takes hold, more agitated wasps may arrive and mount attacks.

In light of these circumstances, development of a chemical agent that can instantly stop carnivorous wasps from behaving normally to prevent injuries, and that can act even faster than pyrethroid insecticides, is desired.

### BACKGROUND ART LITERATURE

### Patent Literature

Patent Literature 1: Japanese Patent Laid-open No. 2017-178793

Patent Literature 2: Japanese Patent Laid-open No. 2015-093846

Patent Literature 3: Japanese Patent Laid-open No. 2011-144151

### SUMMARY OF THE INVENTION

### Problems to be Solved by the Invention

An object of the present invention is to provide a highly fast-acting chemical agent that, when used on carnivorous wasps, instantly stops them from behaving normally, to prevent injuries caused by stings and bites.

### Means for Solving the Problems

As a result of conducting multiple studies in earnest to achieve the aforementioned object, the inventor of the present invention found that, when used on carnivorous wasps such as those belonging to the Vespidae family, a chemical agent containing a cyclic monoterpene-based compound, etc., as an active ingredient would instantly stop them from behaving normally so that they could be controlled, and eventually achieved the aforementioned object.

To be specific, the following items represent the key points of the present invention:

1. A carnivorous wasp control agent characterized in that it contains, as an active ingredient, at least one type of compound selected from the group that consists of (a) cyclic monoterpene-based compounds, (b) chain monoterpene-based aldehyde compounds, (c) chain sesquiterpene-based compounds, (d) benzoic acid alkyl esters, (e) lactic acid alkyl esters, (f) octanols, and (g) phenylacetic acid esters.

2. The carnivorous wasp control agent according to 1, characterized in that it further contains a pyrethroid compound.

3. A spray formulation that contains the carnivorous wasp control agent according to 1 or 2.

4. A method for control carnivorous wasps, characterized in that it involves spraying the spray formulation according to 3 on the carnivorous wasps.

### Effects of the Invention

The carnivorous wasp control agent proposed by the present invention is a chemical agent that contains, as an active ingredient, at least one type of compound selected from the group that consists of (a) cyclic monoterpene-based compounds, (b) chain monoterpene-based aldehyde compounds, (c) chain sesquiterpene-based compounds, (d) benzoic acid alkyl esters, (e) lactic acid alkyl esters, (f) octanols, and (g) phenylacetic acid esters, which, when sprayed or otherwise used on carnivorous wasps such as those belonging to the Vespidae family, demonstrates a fast controlling effect in that the carnivorous wasps are disabled as they instantly stop behaving normally, and begin grooming abnormally and showing agitated behaviors (flapping of wings).

By using the carnivorous wasp control agent proposed by the present invention, a person who unknowingly approached their nest and was therefore attacked by carnivorous wasps such as those belonging to the Vespidae family can control the carnivorous wasps expeditiously and evacuate quickly from the range of activity of the wasps to avoid injuries. Also, when removing a nest of carnivorous wasps such as those belonging to the Vespidae family, the carnivorous wasps around the nest can be controlled expeditiously before the nest is removed, which allows for a safe removal of the nest.

Additionally, the carnivorous wasp control agent proposed by the present invention is very useful in that, when a pyrethroid compound is also used therein, the at least one type of compound selected from the group that consists of (a) to (g) instantly stops the carnivorous wasps from behaving normally, while the pyrethroid compound simultaneously kills or causes knockdown of the carnivorous wasps in such state.

### MODE FOR CARRYING OUT THE INVENTION

The carnivorous wasp control agent proposed by the present invention is explained in detail below.

Under the present invention, “control” means disabling wasps by causing them to instantly stop behaving normally, and begin grooming abnormally and showing agitated behaviors (flapping of wings), which is different from the knockdown effect or killing effect achieved by insecticides, and because their normal behaviors are instantly stopped, the wasps can no longer fly to attack.

Under the present invention, “carnivorous wasps” means predatory wasps that feed on non-carnivorous wasps such as honeybees, other carnivorous wasps, and other insects, etc., and specifically include Hymenopteran pests belonging to the Vespinae subfamily and Polistinae subfamily. Wasps belonging to the Vespinae subfamily include Vespa mandarinia, Vespa simillima, Vespa analis, Vespa crabro, Vespa ducalis, Vespa dybowskii, Vespula flaviceps, Vespula shidai, Vespula austriaca, etc., for example. Also, wasps belonging to the Polistinae subfamily include Polistes rothneyi, Polistes jokahamae, Polistes chinensis, Polistes riparius, Polistes japonicus, Polistes nipponensis, Polistes snelleni, Polistes rothneyi yayeyamae, Parapolybia indica, Parapolybia varia, and other indigenous species, for example. In addition to these indigenous species, Vespa velutina that were introduced to Tsushima and Kitakyushu City are also included in the carnivorous wasps covered by the present invention. Other than the foregoing, other Hymenopteran pests such as Cyphononyx dorsalis, Ammophila sabulosa, and mason wasps are also included.

<Active Ingredient>

The carnivorous wasp control agent proposed by the present invention is characterized in that it contains, as an active ingredient, at least one type of compound selected from the group that consists of (a) cyclic monoterpene-based compounds, (b) chain monoterpene-based aldehyde compounds, (c) chain sesquiterpene-based compounds, (d) benzoic acid alkyl esters, (e) lactic acid alkyl esters, (f) octanols, and (g) phenylacetic acid esters.

The cyclic monoterpene-based compounds (a) represent compounds having a ring structure comprising two isoprene units. To be specific, pinene, terpinene, limonene, and other hydrocarbon compounds, menthone, isomenthone, pulegone, thujone, carvone, camphor, and other ketone compounds, menthol, terpineol, and other alcohol compounds, perillaldehyde, myrtenal, and other aldehyde compounds are included, for example. Among these, the aforementioned hydrocarbon compounds, ketone compounds, and alcohol compounds are preferred, and α-pinene, cineol, menthone, pulegone, thujone, α-terpinene, carvone, and menthol are particularly preferred, as the cyclic monoterpene-based compounds (a).

The chain monoterpene-based aldehyde compounds (b) represent aldehyde compounds having a chain structure comprising two isoprene units. To be specific, citral and citronellal are included, for example, and citral and citronellal are particularly preferred.

The chain sesquiterpene-based compounds (c) represent compounds having a ring structure comprising three isoprene units. To be specific, farnesol and other alcohol compounds as well as isolongifolanone and other ketone compounds are included, for example; among these, the aforementioned alcohol compounds are preferred, and farnesol is particularly preferred.

As the benzoic acid alkyl esters (d), cyclic/chain alkyl esters having 1 to 8 carbon atoms are preferred, and chain alkyl groups having 1 to 6 carbon atoms are more preferred. Among these, benzoic acid methyl ester, benzoic acid ethyl ester, benzoic acid n-propyl ester, and benzoic acid isopropyl ester are preferred.

As the lactic acid alkyl esters (e), cyclic/chain alkyl esters having 1 to 8 carbon atoms are preferred, and chain alkyl groups having 1 to 6 carbon atoms are more preferred. Among these, lactic acid methyl ester, lactic acid ethyl ester, lactic acid n-propyl ester, lactic acid isopropyl ester, and lactic acid n-butyl ester are preferred.

The octanols (f) are alcohols having 8 carbon atoms, including 1-octanol, isooctanol, 3-octanol, 2-ethylhexanol, etc. Among these, 3-octanol is preferred.

As the phenylacetic acid esters (g), chain alkyl esters having 1 to 3 carbon atoms that may have been substituted are preferred, where phenyl groups are preferred substituent groups. Among these, phenylacetic acid methyl ester, phenylacetic acid ethyl ester, and phenylacetic acid benzyl ester are preferred.

Preferably the carnivorous wasp control agent proposed by the present invention contains a cyclic monoterpene-based compound (a) as an essential ingredient. In particular, preferably it contains pinene and/or menthone as an essential ingredient(s).

The carnivorous wasp control agent proposed by the present invention contains the component selected as an active ingredient from the group that consists of (a) to (g), preferably by somewhere in a range of 0.005% by weight or more but no more than 80% by weight, or more preferably in a range of 0.05% by weight or more but no more than 40% by weight, or particularly preferably in a range of 0.1% by weight or more but no more than 20% by weight, relative to the total control agent (if it is an aerosol, its propellant is also included).

The carnivorous wasp control agent proposed by the present invention may be used as various formulations. Types of formulations include oil, emulsion, wettable powder, flowable (water suspension, water emulsion, etc.), microcapsule, powder, granule, tablet, gel, liquid, spray, aerosol, etc., for example. Among these, spray, aerosol, and other spray formulations as well as powder, granules, and other sprinkle formulations are preferred types of formulations under the present invention because the controlling effect can be maximized.

In particular, preferably the carnivorous wasp control agent proposed by the present invention is an aerosol. Such aerosol, which is constituted by a liquid concentrate and a propellant that propels the liquid concentrate, contains the component selected as an active ingredient from the group that consists of (a) to (g), preferably by somewhere in a range of 0.01% by weight or more but no more than 100% by weight, or more preferably in a range of 0.1% by weight or more but no more than 50% by weight, or particularly preferably in a range of 0.5% by weight or more but no more than 30% by weight, in the liquid concentrate.

Liquid carriers that may be used when making formulations include, for example, alcohols (methanol, ethanol, isopropyl alcohol, butanol, hexanol, benzyl alcohol, ethylene glycol, etc.), ethers (diethyl ether, ethylene glycol dimethyl ether, diethylene glycol monomethyl ether, diethylene glycol monoethyl ether, propylene glycol monomethyl ether, tetrahydrofuran, dioxane, etc.), esters (ethyl acetate, butyl acetate, isopropyl myristate, etc.), ketones (acetone, methyl ethyl ketone, methyl isobutyl ketone, cyclohexanone, etc.), aromatic or aliphatic hydrocarbons (xylene, toluene, alkyl naphthalene, phenyl xylyl ethane, kerosene, light oil, hexane, cyclohexane, etc.), halogenated hydrocarbons (chlorobenzene, dichloromethane, dichloroethane, trichloroethane, etc.), nitriles (acetonitrile, isobutyronitrile, etc.), sulfoxides (dimethyl sulfoxide, etc.), heterocyclic solvents (sulfolane, γ-butyrolactone, N-methyl-2-pyrrolidone, N-ethyl-2-pyrrolidone, N-octyl-2-pyrrolidone, 1,3-dimethyl-2-imidazolidinone), acid amides (N,N-dimethylformamide, N,N-dimethylacetamide, etc.), alkylidene carbonates (propylene carbonate, etc.), plant oils (soybean oil, cottonseed oil, etc.), plant-based essential oils (orange oil, hyssop oil, lemon oil, etc.), and water. As for water, tap water, ion-exchanged water, distilled water, filtered water, sterilized water, groundwater, etc., are used.

Under the present invention, a saturated hydrocarbon is a preferred liquid carrier to be used in making an aerosol formulation. Saturated hydrocarbons include paraffinic hydrocarbons and naphthenic hydrocarbons, of which paraffinic hydrocarbons comprising normal paraffins and isoparaffins are preferred. Representative normal paraffins are those whose number of carbon atoms is primarily 12 to 14, including, for example, Neothiozol manufactured by Sanko Chemical Industry Co., Ltd., Normal Paraffin N-12, Normal Paraffin N-13, Normal Paraffin N-14, and Normal Paraffin MA manufactured by JXTG Energy Corporation, and the like, while isoparaffins include, for example, IP Clean LX and IP Solvent manufactured by Idemitsu Kosan Co., Ltd., and the like. Furthermore, as a liquid carrier, preferably one type selected from fatty acid ester-based solvents, glycol ether-based solvents, heterocyclic solvents, ester-based solvents, and alcohol-based solvents is compounded alone, or two or more types are combined.

For the propellant used in an aerosol, any of the wide range of known propellants may be used, such as liquefied petroleum gas (LPG), dimethyl ether, alternative chlorofluorocarbons (such as HFO and HFC), carbon dioxide gas, and nitrogen gas, for example. Among these, use of LPG or dimethyl ether is preferred. In the case of such aerosol, the propellant quantity may account for 30 to 95 percent by volume, particularly 50 to 95 percent by volume, of the total, with the liquid concentrate (total quantity of the active ingredient selected from the group that consists of (a) to (g) above, as well as surfactant, liquid carrier, etc.) accounting for 70 to 5 percent by volume, particularly 50 to 5 percent by volume, of the total.

Surfactants that may be used when making formulations include nonionic surfactants, anionic surfactants, cationic surfactants, and amphoteric surfactants. Nonionic surfactants include, for example, polyoxyalkylene allyl phenyl ethers, polyoxyethylene alkyl ethers, polyoxyethylene alkyl phenyl ethers, polyoxyethylene ally phenyl ethers, polyoxyethylene styryl phenyl ethers, polyoxyethylene alkyl phenyl ether formaldehyde condensates, polyoxyethylene-polyoxypropylene block polymers, polyoxyethylene-polyoxypropylene block polymer alkyl phenyl ethers, sorbitan fatty acid esters (sorbitan monooleate, sorbitan laurate, etc.), polyoxyethylene fatty acid esters, polyoxyethylene sorbitan fatty acid esters, polyoxyethylene hardened castor oil, polyethylene glycol fatty acid esters, polyethylene glycol fatty acid ethers, etc. Anionic surfactants include, for example: sodium, calcium or ammonium salts of alkyl sulfates, polyoxyethylene alkyl ether sulfates, polyoxyethylene alkyl phenyl ether sulfates, polyoxyethylene benzyl (or styryl) phenyl ether sulfates, and polyoxyethylene-polyoxypropylene block polymer sulfates; sodium, calcium, ammonium, or alkanolamine salts of alkyl sulfonates, dialkyl sulfosuccinates, alkylbenzene sulfonic acids (calcium dodecylbenzene sulfonates, etc.), mono- or di-alkyl naphthalene acid sulfonic acids, naphthalene sulfonic acid formaldehyde condensates, lignin sulfonic acids, polyoxyethylene alkyl phenyl ether sulfonic acids, and polyoxyethylene alkyl ether sulfosuccinates; and sodium, calcium, and other salts of polyoxyethylene alkyl ether phosphates, polyoxyethylene, mono- or di-alkyl phenyl ether phosphates, polyoxyethylene benzylated (or styrylated) phenyl ether phosphates, and polyoxyethylene-polyoxypropylene block polymer phosphates. Cationic surfactants include, for example, quaternary ammonium salts, alkylamine salts, alkylpyridinium salts, alkyl oxides, etc. Amphoteric surfactants include, for example, alkyl betaines, amine oxides, etc.

Solid carriers that may be used when making formulations include, for example, clays (kaolin, diatomaceous earth, bentonite, clay, acid clay, etc.), synthetic hydrous silicon oxide, talc, ceramic, other inorganic minerals (sericite, quartz, sulfur, active carbon, calcium carbonate, hydrated silica, etc.), and porous bodies, and the like. In terms of particle size, solid carriers whose particle size is in a range of 0.01 μm to 15 mm are preferred, of which those whose particle size is in a range of 0.1 μm to 10 mm are more preferred.

Under the present invention, antifreeze agent, defoaming agent, preservative, antioxidant, thickening agent, etc., may be added as necessary when making formulations.

Antifreeze agents include, for example, ethanol, ethylene glycol, propylene glycol, ethyl cellosolve, butyl carbitol, 3-methyl-methoxybutanol, etc.

Defoaming agents include, for example, Antifoam E-20 (product name, silicone emulsion, Kao Corporation), Antifoam C (product name, Toray Dow Corning Co., Ltd.), Antifoam C Emulsion (product name, Toray Dow Corning Co., Ltd.), Rhodorsil 454 (product name, Solvay S.A.), Rhodorsil Antifoam 432 (product name, Solvay S.A.), TSA 730 (product name, TANAC Co., Ltd.), TSA 731 (product name, TANAC Co., Ltd.), TSA 732 (product name, TANAC Co., Ltd.), YMA 6509 (product name, TANAC Co., Ltd.) and other silicone-based defoaming agents, as well as Fluowet PL80 (product name, Clariant AG) and other fluorine-based defoaming agents.

Preservatives include, for example, Biohope and Biohope L (chemical names: organic nitrogen sulfur-based complex, organic bromine-based compound), Bestcide 750 (chemical name: isothiazoline-based compound, 2.5 to 6.0 percent), Preventol D2 (chemical name: benzyl alcohol mono(poly)hemiformal), PROXEL GXL (S) (chemical name: 1,2-benzoisothiazoline-3-one, 20 percent), 5-chloro-2-methyl-4-isothiazoline-3-one, 2-methyl-4-isothiazoline-3-one, 2-bromo-2-nitropropane-1,3-diol, potassium sorbate, sodium dehydroacetate, etc.

Antioxidants include tetrakis[methylene-3-(3,5-di-t-butyl-4-hydroxyphenyl)propionate]methane (product name Tominox TT, API Corporation/product names IRGANOX 1010 or IRGANOX 1010 EDS, Chiba Japan Corporation), butylated hydroxytoluene (BHT), butylated hydroxyanisole (BHA), propyl gallate, as well as vitamin E, mixed tocopherol, α-tocopherol, ethoxyquin, ascorbic acid, etc.

The carnivorous wasp control agent proposed by the present invention can, when compounded with an insecticidal ingredient effective on carnivorous wasps, cause such wasps to immediately stop behaving normally, and begin grooming abnormally and showing agitated behaviors (flapping of wings), or further killing the wasps or causing knockdown. To be specific, insecticidal ingredients that may be compounded include, for example: allethrin, resmethrin, furamethrin, prallethrin, terallethrin, phthalthrin, phenothrin, permethrin, cyphenothrin, cypermethrin, transfluthrin, metofluthrin, profluthrin, imiprothrin, empenthrin, momfluorothrin, etofenprox, silafluofen, bifenthrin, and other pyrethroid compounds; propoxur, carbaryl, and other carbamate compounds; fenitrothion, DDVP, and other organic phosphorus compounds; metoxadiazone and other oxadiazole compounds; fipronil and other phenyl pyrazole compounds; amidoflumet and other nitroguanidine compounds; imidacloprid, dinotefuran, and other neonicotinoid compounds; methoprene, hydroprene, and other insect juvenile hormone-like compounds; and precocene and other anti juvenile hormone-like compounds, for example, which may be combined with synepirin, piperonyl butoxide, and other synergists. Of these insecticidal ingredients, one type may be used alone, or two or more types may be combined according to the purpose. In particular, by compounding the component selected as an active ingredient from the group that consists of (a) to (g) with a pyrethroid compound, the carnivorous wasp control agent proposed by the present invention can cause carnivorous wasps to immediately stop behaving normally, and begin grooming abnormally and showing agitated behaviors (flapping of wings) so that the wasps can be killed or undergo knockdown in such state, which makes this control agent very useful. Among the pyrethroid compounds, phthalthrin, imiprothrin, momfluorothrin, prallethrin, and pyrethrin are suitable.

The carnivorous wasp control agent proposed by the present invention can demonstrate a controlling effect against carnivorous wasps, when used on them, in that they instantly stop behaving normally and begin grooming abnormally and showing agitated behaviors (flapping of wings), and also when it is applied on a nest of carnivorous wasps, the carnivorous wasps in the nest instantly stop behaving normally and begin grooming abnormally and showing agitated behaviors (flapping of wings), which makes this control agent extremely effective for removing nests of carnivorous wasps.

### EXAMPLES

The present invention is explained in greater detail below using formula examples, test examples, etc.; it should be noted, however, that the present invention is not limited to these examples.

Examples of test samples of the carnivorous wasp control agent proposed by the present invention are described.

<Control Test 1>

(1) Preparation of Test Samples (Aerosols)

### Example 1

Ten grams of ethyl lactate, which is an active ingredient under the present invention, was put in an aerosol can as a liquid concentrate, and then a valve part was installed on the can, after which dimethyl ether was filled through the valve part as a propellant until the weight ratio of the liquid concentrate and the propellant became 1:2, and then a spray button was installed, to obtain 30 g of aerosol test sample in Example 1.

In Examples 2 to 28 and Comparative Examples 1 to 6, the liquid concentrates shown in Table 1 below were used to obtain 30 g of respective test samples in the same manner as in Example 1.

(2) Test Method and Evaluation Method

One test wasp as specified in Table 1 was put in a metal mesh gauge (25 cm×25 cm×25 cm, 20 mesh), after which 2 g of each aerosol test sample was sprayed (for 1 second) from a distance of approx. 30 cm from the test wasp, and the behaviors of the test wasp were observed for up to 180 seconds. After spraying, the time it took for the test wasp to stop behaving normally and begin grooming abnormally and showing agitated behaviors (flapping of wings), and eventually drop to the bottom of the metal gauge, was measured as the control time (in seconds). The results are summarized and shown in Table 1. In Table 1, “IPA” stands for isopropanol, while “%” refers to % by weight.

It should be noted that “turpentine oil” in Examples 2 and 3 is a plant-based essential oil containing 85% by weight or more of α-pinene which is an active ingredient under the present invention, while Comparative Example 5 contains 1% by weight of isopropyl myristate as a dissolving aid.

TABLE 1

| | | Liquid concentrate <Active ingredient, | | | Control time |
|---|---|---|---|---|---|
| | | one of (a) to (g)> | | Test wasp | (sec) |
| Examples | 1 | Ethyl lactate | (e) | Polistes jokahamae | <1 |
| | 2 | Turpentine oil | (a) | Polistes jokahamae | <1 |
| | 3 | 20% turpentine oil/n-paraffin | (a) | Polistes jokahamae | <1 |
| | | solution | | | |
| | 4 | Menthone | (a) | Polistes jokahamae | <1 |
| | 5 | Menthone | (a) | Vespa ducalis | <1 |
| | 6 | Methyl benzoate | (d) | Polistes rothneyi | <1 |
| | 7 | Ethyl benzoate | (d) | Polistes rothneyi | <1 |
| | 8 | Farnesol | (c) | Polistes rothneyi | <1 |
| | 9 | α-turpentine | (a) | Polistes rothneyi | <1 |
| | 10 | Pulegone | (a) | Polistes rothneyi | <1 |
| | 11 | Citral | (b) | Polistes rothneyi | <1 |
| | 12 | Thujone | (a) | Polistes rothneyi | <1 |
| | 13 | 3-octanol | (f) | Polistes rothneyi | <1 |
| | 14 | Benzyl phenyl acetate | (g) | Polistes rothneyi | <1 |
| | 15 | 1% menthone/IPA solution | (a) | Polistes jokahamae | <1 |
| | 16 | 5% menthone/IPA solution | (a) | Polistes jokahamae | <1 |
| | 17 | 10% menthone/IPA solution | (a) | Polistes jokahamae | <1 |
| | 18 | 20% menthone/IPA solution | (a) | Polistes jokahamae | <1 |
| | 19 | 50% menthone/IPA solution | (a) | Polistes jokahamae | <1 |
| | 20 | Cineol | (a) | Polistes rothneyi | <1 |
| | 21 | Menthol | (a) | Polistes jokahamae | <1 |
| | 22 | 50% menthol/IPA solution | (a) | Polistes jokahamae | <1 |
| | 23 | Carvone | (a) | Polistes jokahamae | <1 |
| | 24 | 50% carvone/IPA solution | (a) | Polistes jokahamae | <1 |
| | 25 | 50% citronellal/IPA solution | (b) | Polistes jokahamae | <1 |
| | 26 | Methyl lactate | (e) | Polistes jokahamae | <1 |
| | 27 | n-butyl lactate | (e) | Polistes jokahamae | <1 |
| | 28 | Methyl phenyl acetate | (g) | Polistes jokahamae | <1 |
| Comparative | 1 | n-paraffin | — | Vespa simillima | >180 |
| Examples | 2 | Menthyl acetate | — | Vespa simillima | >180 |
| | 3 | Linalool | — | Vespa mandarinia | >180 |
| | 4 | 1% permethrin/isoparaffin | — | Polistes jokahamae | 61 |
| | | solution | | | |
| | 5 | 1% imiprothrin/isoparaffin | — | Polistes jokahamae | 29 |
| | | solution | | | |
| | 6 | IPA | — | Polistes jokahamae | >180 |

As shown in Table 1, the components selected from the group that consists of (a) to (g) under the present invention were clearly able to control the carnivorous wasps belonging to the Vespidae family when sprayed on them, by causing the carnivorous wasps to immediately stop behaving normally, and begin grooming abnormally and showing agitated behaviors (flapping of wings).

<Control Test 2 (Outdoors)>

(1) Preparation of Test Samples (Aerosols)

Aerosol A

Twenty grams of turpentine oil that had been dissolved in 80 g of n-paraffin solution was put in an aerosol can as a liquid concentrate, and then a valve part was installed on the can, after which dimethyl ether was filled through the valve part as a propellant until the weight ratio of the liquid concentrate and the propellant became 1:2, and then a spray button was installed, to obtain 300 g of test sample of Aerosol A.

Aerosol B

One hundred milliliters of a mixture of 1.3% by weight of phthalthrin, 0.05% by weight of bifenthrin, 1% by weight of menthone and an appropriate quantity of isopropanol (IPA) was put in an aerosol can as a liquid concentrate, and then a valve part was installed on the can, after which dimethyl ether was filled through the valve part as a propellant until the volume ratio of the liquid concentrate and the propellant became 1:1, and then a spray button was installed, to obtain 200 mL of test sample of Aerosol B.

Aerosol C

One hundred milliliters of a mixture of 1.3% by weight of phthalthrin, 0.05% by weight of bifenthrin, 50% by weight of menthone, and an appropriate quantity of isopropanol (IPA) was put in an aerosol can as a liquid concentrate, and then a valve part was installed on the can, after which dimethyl ether was filled through the valve part as a propellant until the volume ratio of the liquid concentrate and the propellant became 1:1, and then a spray button was installed, to obtain 200 mL of test sample of Aerosol C.

(2) Test Method and Evaluation Method

Using the test samples of aerosols A to C above, 100 g of each test sample was sprayed (for 10 seconds) on a nest of Polistes jokahamae present in an outdoor location (Ako City, Hyogo Prefecture) from the distance specified in Table 2, and the behaviors of the Polistes jokahamae were observed.

For the test result, a “◯” was given as an evaluation of controlling effect if, after storming out of the nest, the Polistes jokahamae stopped behaving normally, and began grooming abnormally and showing agitated behaviors (flapping of wings) within 1 second. The test results are summarized and shown in Table 2.

TABLE 2

| | Examples | | |
|---|---|---|---|
| | 29 | 30 | 31 |
| Test sample | Aerosol A | Aerosol B | Aerosol C |
| Active ingredient | Turpentine oil | Menthone | Menthone |
| under the present | 20% by | 1% by | 50% by |
| invention | weight | weight | weight |
| Pyrethroid compound | — | Phthalthrin | |
| | | Bifenthrin | |
| Nest size | 5 cm | 20 cm | 5 cm |
| Spray distance | 1 m | | |
| Evaluation of | ◯ | ◯ | ◯ |
| control effect | | | |

The test results are explained in detail. Immediately after being sprayed, the carnivorous wasp control agent conforming to the present invention and not containing any pyrethroid compound (Example 29) caused the carnivorous wasps to instantly stop behaving normally and begin grooming abnormally and showing agitated behaviors (flapping of wings), and dropped to the ground. Although the controlling effect intended by the present invention was achieved, after a short while the carnivorous wasps began flapping their wings normally and flew. On the other hand, immediately after being sprayed, the carnivorous wasp control agents conforming to the present invention and containing a pyrethroid compound (Examples 30, 31) caused the carnivorous wasps to instantly stop behaving normally, and begin grooming abnormally and showing agitated behaviors (flapping of wings), and after dropping to the ground, they did not resume activity. In particular, when Example 30 whose menthone content was extremely low at 1% by weight was used on a large 20-cm nest of the extremely belligerent carnivorous wasps called “Polistes jokahamae,” all of the carnivorous wasps instantly stopped behaving normally and died.

<Control Test 3 (Outdoors)>

(1) Preparation of Test Samples (Aerosols)

Aerosol D

One hundred milliliters of a mixture of 1.3% by weight of phthalthrin, 0.05% by weight of bifenthrin, 1% by weight of menthone, and an appropriate quantity of isoparaffin was put in an aerosol can as a liquid concentrate, and then a valve part was installed on the can, after which dimethyl ether was filled through the valve part as a propellant until the volume ratio of the liquid concentrate and the propellant became 1:1, and then a spray button was installed, to obtain 200 mL of test sample of Aerosol D.

(2) Test Method and Evaluation Method

Using the test sample of Aerosol B in <Control Test 2 (Outdoors)> as previously mentioned and that of Aerosol D above, 100 g of each test sample was sprayed (for 10 seconds) on a nest of carnivorous wasps present in an outdoor location (Ako City, Hyogo Prefecture) from the distance specified in Table 3, and the behaviors of the carnivorous wasps were observed.

For the test result, a “◯” was given as an evaluation of controlling effect if, after storming out of the nest, the carnivorous wasps stopped behaving normally and began grooming abnormally and showing agitated behaviors (flapping of wings) within 1 second. The test results are summarized and shown in Table 3.

TABLE 3

| | Examples | | | |
|---|---|---|---|---|
| | 32 | 33 | 34 | 35 |
| Test sample | Aerosol B | | | Aerosol D |
| Active ingredient under | Menthone | | | |
| the present invention | 1% by weight | | | |
| Solvent | IPA | | | Isoparaffin |
| Pyrethroid compound | Phthalthrin | | | |
| | Bifenthrin | | | |
| Type of carnivorous | Polistes | Polistes | Vespa | Polistes |
| wasps | jokahamae | jokahamae | simillima | jokahamae |
| Nest size | 20 cm | 20 cm | 25 cm | 20 cm |
| Spray distance | 1 m | 1 m | 1-2 m | 1 m |
| Evaluation of | ◯ | ◯ | ◯ | ◯ |
| controlling effect | | | | |

The test results are explained in detail. Immediately after being sprayed, the carnivorous wasp control agents conforming to the present invention (Examples 32 to 35) caused all carnivorous wasps, regardless of the type, to instantly stop behaving normally, and begin grooming abnormally and showing agitated behaviors (flapping of wings), and after dropping to the ground, they did not resume activity. Also, there was no difference in the controlling effect as intended by the present invention between Examples 32 to 34 using Aerosol B whose solvent is isopropanol (IPA), and Example 35 using Aerosol D whose solvent is isoparaffin. Additionally, Example 35 did not have any noticeable smell due to menthone and the solvent.

### INDUSTRIAL FIELD OF APPLICATION

By using the carnivorous wasp control agent proposed by the present invention, such carnivorous wasps can be controlled expeditiously, allowing people to quickly evacuate from the range of activity of the wasps to avoid injuries. Also, when removing a nest of carnivorous wasps such as those belonging to the Vespidae family, the carnivorous wasps around the nest can be controlled expeditiously before the nest is removed, which allows for a safe removal of the nest.

Additionally, the carnivorous wasp control agent proposed by the present invention is very useful in that, when a pyrethroid compound is also used therein, the at least one type of compound selected from the group that consists of (a) to (g) instantly stops the carnivorous wasps from behaving normally, while the pyrethroid compound simultaneously kills or causes knockdown of the carnivorous wasps in such state.

1. A carnivorous wasp control agent characterized by containing, as an active ingredient, at least one compound selected from a group that consists of (a) cyclic monoterpene-based compounds, (b) chain monoterpene-based aldehyde compounds, (c) chain sesquiterpene-based compounds, (d) benzoic acid alkyl esters, (e) lactic acid alkyl esters, (f) octanols, (g) phenylacetic acid esters in an effective amount for controlling carnivorous wasps; and an insecticidally acceptable carrier.

2. The carnivorous wasp control agent according to claim 1, characterized by further containing a pyrethroid compound.

3. A spray formulation that contains the carnivorous wasp control agent according to claim 1.

4. A method for control carnivorous wasps, characterized by involving spraying the spray formulation according to claim 3 on carnivorous wasps.

5. A spray formulation that contains the carnivorous wasp control agent according to claim 2.

6. A method for control carnivorous wasps, characterized by involving spraying the spray formulation according to claim 5 on carnivorous wasps.
